(19) United States
(12) Patent Application Publication
(10) Pub. No.: US 2004/0052907 A1
(43) Pub. Date: Mar. 18, 2004

(54) Vertically oriented laminated dough product

(76) Inventors: Douglas C. Maniak, Ramsey, MN (US); Sherri A. Slocum, Plymouth, MN (US); Susan Y. deWerff, Minnetonka, MN (US); Janet L. Boyle, St. Paul, MN (US); Amy B. Larson Kolbe, Woodbury, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/246,784

(22) Filed: Sep. 18, 2002

(51) Int. Cl. A23G 3/00

(52) U.S. Cl. 426/94

(57) ABSTRACT

A laminated dough product baked while the laminated sheets are oriented substantially vertically to allow the sheets to expand substantially horizontally. Such laminated dough pieces may be partially constrained during baking to limit the amount of horizontal expansion in the area of constraint.

### FIELD OF THE INVENTION

The invention relates to edible laminated dough products having a plurality of laminated layers. The invention relates to a novel shape and orientation for baking such laminated dough products such that the laminated dough products expand in a horizontal direction.

### BACKGROUND OF THE INVENTION

Laminated dough having a plurality of laminated layers is known in the baking art. Laminated dough generally comprises a plurality of layers of alternating fat such as vegetable oil, shortening, or butter with dough. The dough is rolled out to a sheet, folded several times and rolled out again, care being taken that the sheets do not adhere more than spot wise by introducing separating layers of fat or dry flour. The precise number of layers of laminated dough and the thickness and other characteristics that are desired in a given instance vary depending on the particular product. The fat used in between the layers of dough in a laminated dough is important. Laminated dough shortening almost always contains an aqueous phase. The fat keeps the layers of dough separate and flaky, and the moisture attributes the “puff” or lift as it turns to steam during the baking process.

Laminated dough is generally used to make croissants, Danish pastry and other laminated pastry, especially puff pastry. Laminated dough containing products are conventionally oriented during baking so the laminated sheets are parallel to the baking sheet or other support. When the aqueous phase of the shortening turns to steam, this causes the product to expand upwardly during baking, pushing the laminated layers apart. Once the baked product is removed from the oven, cooling and gravity act on the pastry and the previous expansion is somewhat compressed. The baked good “falls” and although it does not fully return to its pre-baked size, it becomes substantially smaller than its in the oven size.

The texture of baked laminated dough products that are baked with the laminated sheets parallel to the support surface varies from the top of the product to the bottom of the product. While the top of the product is very flaky, the bottom of the product suffers from a compression of the laminated layers and often is greasy due to the concentration of laminated layers and, therefore, concentration of the shortening that was spread between the layers.

Consumers enjoy the convenience of frozen dough products. Frozen ready to bake doughs are desirable for commercial and home baking because they minimize a cook's preparation time and are easy to use. Numerous products are currently sold frozen. Many of these products do not require thawing before baking. These types of products are generally called freezer to oven products. Consumers are able to place a freezer to oven product directly from the freezer into the oven without requiring afore thought of taking the product out of the freezer in time to allow the product to thaw before baking.

### SUMMARY OF THE INVENTION

The invention provides a method of baking a laminated dough product in a vertical orientation in order to create a product having a desirable baked shape. A desirable pre-baked shape allows the use of simple, easily comprehensible instructions in order to achieve optimum baked results. Choosing desirable pre-baked shapes in combination with the method of baking also lends to desirable ultimate baked shapes.

### DETAILED DESCRIPTION OF THE DRAWINGS

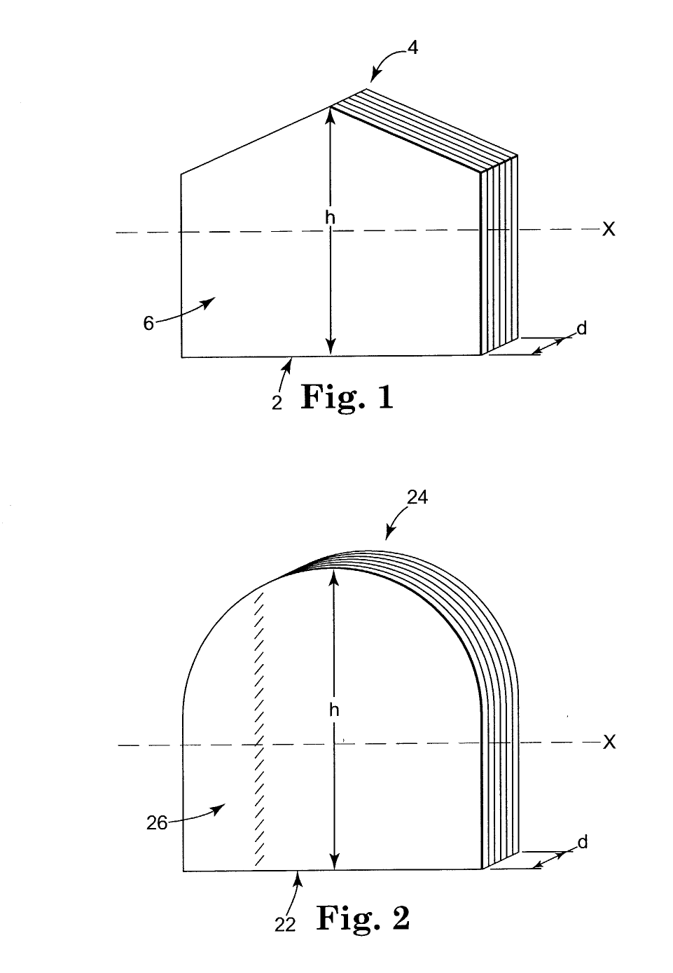

FIG. 1 is a perspective view of a “house” shaped raw dough piece useful in the invention;

FIG. 2 is a perspective view of a domed raw dough piece useful in the present invention;

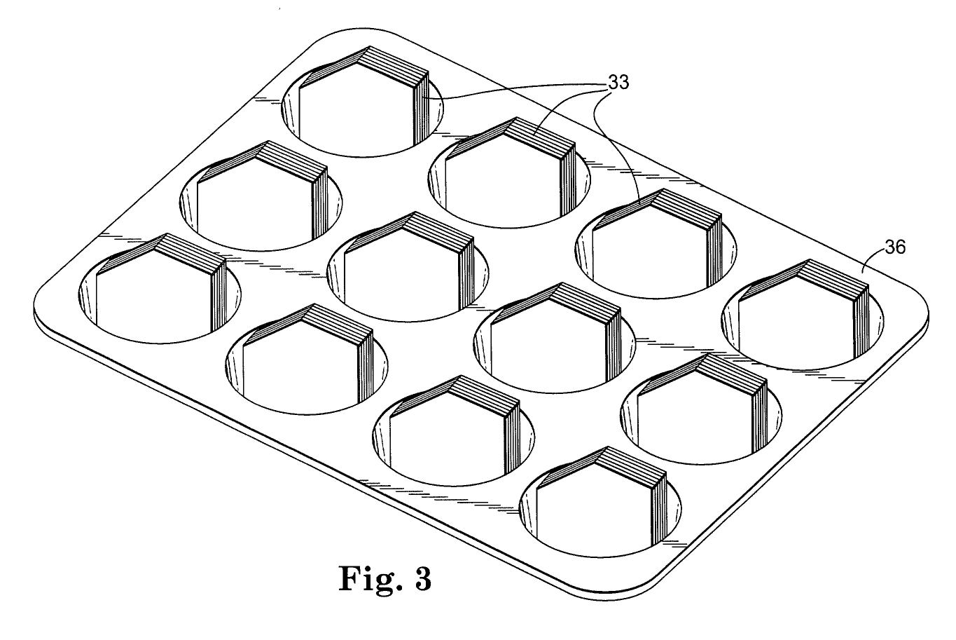

FIG. 3 is a perspective view of a plurality of house shaped raw dough pieces placed in a pan that provides partial constraint of expansion during baking;

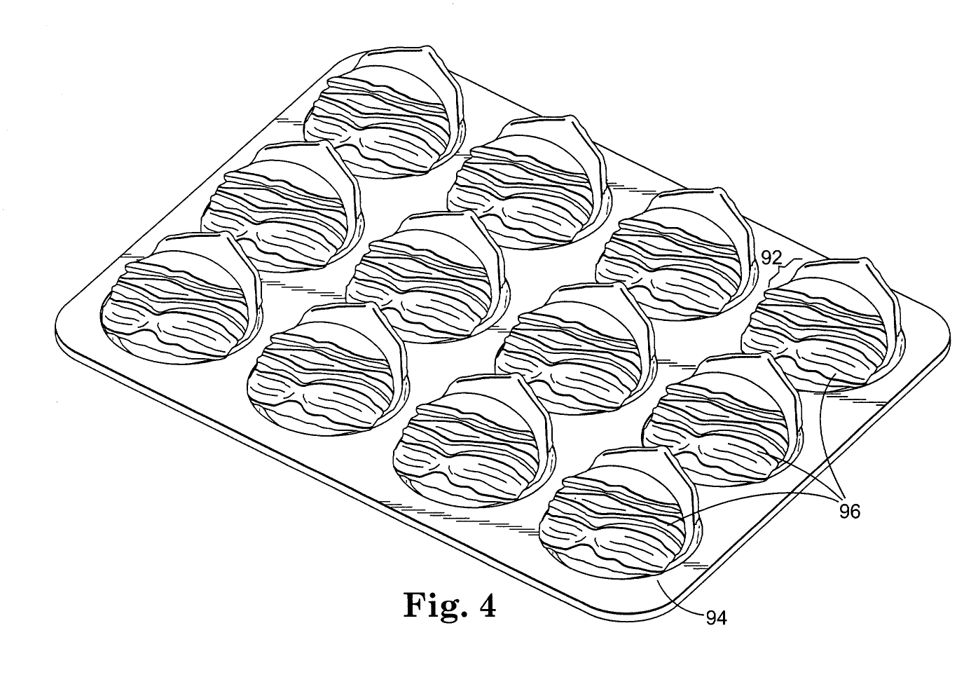

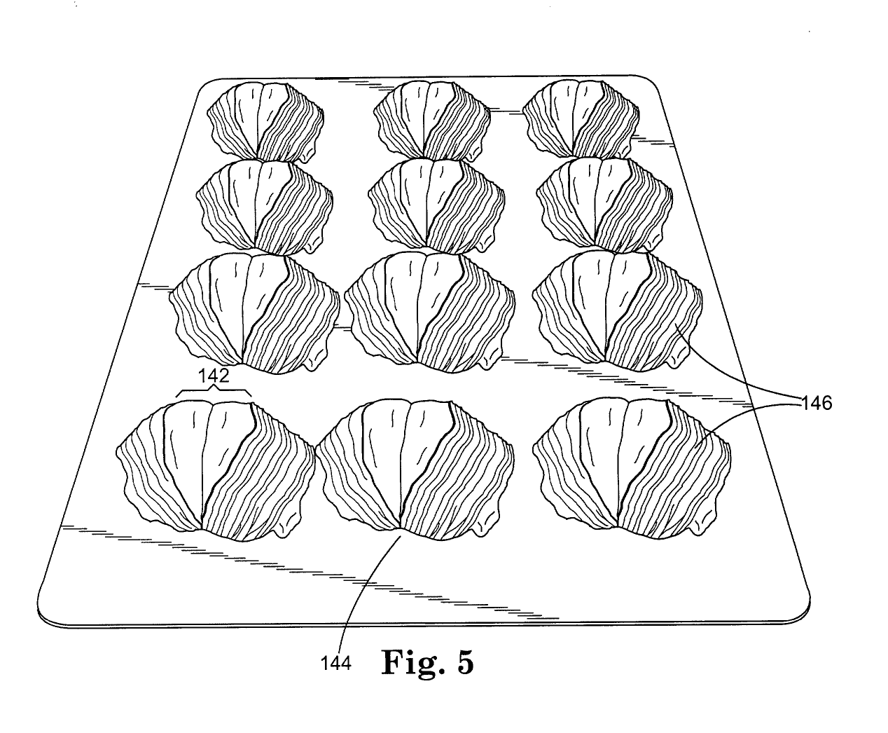

FIG. 4 is a perspective view of the baked product that results from baking the raw dough pieces shown in FIG. 3; and

FIG. 5 is a perspective view of the baked product that results when the raw dough piece shown in FIG. 1 is baked without constraints.

### DETAILED DESCRIPTION OF THE INVENTION

It has surprisingly been found that desirable baked shapes of laminated dough products are achieved when the laminated layers are placed substantially perpendicular to the baking or support surface or vertically. As used herein the term “vertical,” or “upright” refers to a direction parallel to the pull of gravity. The term “horizontal” as used herein refers to a direction perpendicular to the pull of gravity. As is known in the art of laminated dough, the shortening spread between the layers of dough includes an aqueous phase. As the laminated dough is heated during baking, the water in the shortening and in the layer dough turns to steam. This steam that is created during baking pushes the layers of dough apart and causes the laminated layers to expand. In the present invention the expansion is largely horizontal or parallel to the baking surface.

As stated above, the baked size of the product that results from baking the laminated dough pieces with the layers substantially vertical is desirable for the consumer because the baked product is fluffy and large in appearance. However, no additional dough is used to create the large baked good. Consumers therefore enjoy a large product without consuming additional calories often associated with jumbo-sized baked goods.

Additionally, when practicing the positioning method of the invention, the texture throughout the baked product is also desirable. Since the laminated layers do not lie horizontally on top of each other they cannot collapse as a conventionally baked laminated dough product would collapse. Therefore, there is no heavy concentration of layers of dough and shortening at the bottom of the product. When the “bottom” of a product is mentioned, we refer to the surface near and immediately adjacent the baking surface. A laminated dough product baked in the orientation of the invention has a more continuous texture throughout the baked good without the heavy concentration of dough and shortening near the bottom as would be obtained when baking the same dough piece conventionally.

The invention provides a method of positioning a laminated dough product on a baking surface in order to obtain a desired expansion. The laminated dough must be stiff enough to stand with its layers substantially perpendicular to the baking surface before and at least during the initial stages of baking. This is accomplished in any number of ways. First, the dough could be sufficiently stiff. A stiff dough is achieved any number of ways. A stiff dough might be prepared using a high flour content. Alternatively, a high protein containing dough might be used to prepare the dough. Additionally, gluten might be added to the composition to add structure and thereby add stiffness to the dough. Second, the temperature of the dough could be cold enough to allow a pliable dough to remain with its layers substantially perpendicular to the baking surface. Third, a combination of dough stiffness and temperature might be used to maintain the laminated layers in a substantially vertical fashion. If a pliable dough is used, the laminated dough is preferably frozen when it is placed upon the baking surface. However, cold laminated dough, such as refrigerator temperature, about 40 degrees Fahrenheit, would most likely perform well to create the desired expansion and result in a desirable shape. The dough must be cold and/or stiff enough to allow the dough to layers to stand substantially on end or in a substantially vertical orientation. In other words, the laminated layers are disposed perpendicular to the baking surface. In order to practice the method of the invention the laminated dough must stand substantially upright with the laminated layers vertical or near vertical without allowing the layers to flop over, or to slump, or to separate prematurely. It is preferable to place the laminated dough pieces into the oven while the laminated layers are substantially vertical. One skilled in the art will appreciate whether or not a given dough composition must be chilled or frozen in order to allow it to remain substantially vertical.

In one embodiment of the invention a freezer to oven laminated dough is used. Such a dough does not require proofing either before freezing or baking to produce a desirable product. Proofing describes the process of letting a dough product double in size by reaction of yeast before baking. The laminated dough useful in this invention can be removed from the freezer and placed directly in an oven without thawing, and the dough proofs in the oven during baking. The oven can be cold or preheated. The baking temperature and time can depend on, for example, the size and shape of the laminated dough as well as whether the oven is cold or preheated. The temperature of the oven can be in the range of, for example, between about 340 degrees Fahrenheit and about 375 degrees, preferably between about 345 degrees F. and about 355 degrees F., and more preferably between about 350 degrees F. and 352 degrees F. The dough can be baked at this temperature for between about 21 minutes and about 28 minutes, and more preferably between about 22 minutes and about 24 minutes.

Composition

A laminated dough useful in the present invention includes flour, water, a water-binding agent, a leavening agent, and a fat source. The laminated dough may also include one or more of several additional ingredients, such as dough stabilizing agents. Laminated doughs generally include about 8 to about 64 layers of shortening and preferably about 16 to about 48 layers of shortening. A shortening layer includes shortening as described below. A dough layer includes a flour-water containing composition prepared from flour, water, a water-binding agent, a leavening agent, and a fat source. The shortening layers alternate with flour-water layers. To distinguish the dough of the flour-water layers from the laminated dough of the invention, the dough of the flour-water layers is referred to as layer dough whereas the laminated dough having a plurality of layers of shortening and layer dough is referred to as “laminated dough.”

Flour

The layer dough useful in the present invention includes a grain constituent that contributes to the structure of the dough. Wheat flour is a grain constituent that is frequently used in baked goods. Suitable flours include hard wheat winter and spring flours with protein ranges of about 10.8 weight percent to about 16 weight percent. A high protein flour (for example, a flour containing about 12 to about 16 weight percent protein) is preferred, but flours can be supplemented with a protein supplement such as gluten, for example, when the protein content of the flour is lower than desired. Although less preferred, soft wheat flour or lower protein flours can also be used.

A layer dough of the invention typically includes an amount of flour effective to provide structure to the dough. That is, a layer dough of the invention includes flour in an amount effective to provide desirable layer dough consistency. The amount of flour should not be so high that the layer dough is dry and loses its ability to expand. Yet the amount of flour should not be so low that the layer dough is so soft that it merges with the shortening layers in a laminated dough. A layer dough useful in the present invention may include flour in an amount of between about 30 weight percent and about 50 weight percent, and more preferably between about 40 weight percent and about 45 weight percent.

These flour amounts are based on flour having about 13 weight percent to about 15 weight percent moisture, about 12 weight percent to about 14 weight percent wheat protein, and about 0.4 weight percent to about 0.6 weight percent ash based on the amount of flour. One skilled in the art having read the specification would understand that flour amounts suitable for use with a layer dough of the invention can vary depending on the characteristics of flour used.

The term “weight percent” as used herein is based on the total weight of the laminated dough including the dough layers and the shortening layers, unless specifically indicated to the contrary.

Water

A layer dough of the invention also includes water. The amount of water from all sources should be effective to provide a desirable dough consistency suitable for a layer dough useful in the invention. Water can act as a plasticizer, a leavening agent, or both.

When water acts as a plasticizer, water gives extensibility to the layer dough, which facilitates the molecules moving and stretching. Desirable extensibility facilitates the layer dough of the invention baking into a product having a desirable specific volume. A desirable baked specific volume includes a specific volume of at least 2.5 cc/g, preferably between about 2.6 cc/g and about 3.1 cc/g, and more preferably between about 2.7 cc/g and about 2.9 cc/g. These baked specific volumes result when the dough is baked with restraints. If the dough is baked without restraints the BSVs are generally about 0.1 to 0.3 cc/g larger. That is, dough that is placed vertically on a flat sheet have about 0.1 to about 0.3 cc/g larger baked specific volumes as those that are baked in muffin tins.

Moreover, water can facilitate the leavening of a laminated dough of the invention by forming steam, which acts as a leavening agent.

The amount of water from all sources, for example, water, eggs, milk, etc., should not be so high that the laminated dough is so soft that it loses its layers because the individual dough layers merge with the shortening layers. Yet the amount of water from all sources should not be so low that the layer dough is so dry that it loses its ability to expand. Typically a dough of the invention includes flour and water in a flour to water ratio in a range of between about 1.5:1 and about 2.5:1, preferably between about 1.6:1 and about 2.0:1, and more preferably between about 1.7:1 and about 1.9:1.

Protein Supplement

A layer dough of the invention may include a protein supplement to provide structure to the layer dough. A protein supplement can contribute to a baked product prepared from a laminated dough of the invention having a crisp, brown outer crust as well as a tender interior that is moist but not doughy. Protein supplements that provide these characteristics can generally be used.

A suitable protein supplement can include proteins resulting from amino acids such as, for example, glycine, alanine, leucine, isoleucine, valine, phentolamine, turicine, tryptophan, proline, methionine, cystine, serine, threonine, asparagine, glutamine, histidine, aspartic acid, glutamic acid, lysine, and arginine. Other suitable protein supplements include, for example, α-keratin, collagen, fibroin, sclerolin, myosin, actin, carboxypeptidase, trypsin, ovalbumin, casein, and the like.

A layer dough useful in the invention may include a dairy protein, an egg protein, a wheat protein, or a combination thereof. Examples of suitable dairy proteins include whey, caseinate, buttermilk, buttermilk solids, and nonfat dry milk.

Examples of suitable egg proteins include albumin.

Examples of suitable wheat proteins include gluten or those derived from flour.

Alternatively, a soy protein could be used.

A layer dough useful in the invention includes a protein supplement in an amount from all sources, for example, eggs, flour, gluten, etc., effective to provide a baked product having a crisp exterior and a moist but nondoughy interior. The amount of protein supplement should not exceed an amount that would provide a tough, crumbly baked product. Yet the amount of protein supplement should not be so low that a laminated dough provides a baked product having a gummy, doughy texture. A layer dough useful in the invention typically includes a protein supplement in a range of between about 0.4 weight percent and about 2.5 weight percent, preferably between about 0.6 weight percent and about 2.3 weight percent, and more preferably between about 0.8 weight percent and about 1.5 weight percent based on the total weight of the laminated dough.

Shortening

A laminated dough useful in the invention also includes a shortening. Shortening contributes to a baked product having desirable palatability, physical texture, physical form, and overall aesthetic appeal. The shortening generally provides a baked product with a tender, soft, fluffy mouth feel; a light flaky texture; and a crisp outer crust with a glossy appearance. Shortening can also act as a plasticizer in the layer dough and can contribute to the volume and grain of a baked product.

Shortening in the layer dough can be natural, for example, animal or vegetable shortening, or synthetic. Shortening in the layer dough generally includes fats and fatty oils, which are made of predominantly triesters of glycerol with fatty acids, commonly called triglycerides. The number of triglycerides in a given natural fat is a function of the number of fatty acids present and specificity of the enzyme systems involved in that particular fat-synthesis reaction.

Fats and fatty oils useful in producing shortening consistent with the invention include cottonseed oil, ground nut oil, soybean oil, sunflower oil, rape seed oil, sesame oil, olive oil, corn oil, safflower oil, palm oil, palm kernel oil, coconut oil, and combinations thereof.

The layer dough in the laminated dough useful in the invention can include any number of shortening compositions having a variety of physical states and/or physical forms. Suitable physical states of shortening include liquid, semisolid, and solid. Suitable physical forms of shortening include plasticized shortening, chip shortening, and extruded shortening. Preferably the shortening in the layer dough includes butter, hydrogenated vegetable oil, hydrogenated soybean oil, or a combination thereof.

Shortening in the shortening layers of a laminated dough useful in the invention includes any solid shortening, which can be natural or synthetic as described above. Preferably the shortening in the shortening layers includes butter.

The amount of shortening in a laminated dough useful in the present invention is effective to provide a baked product having a tender, soft, fluffy mouth feel; a light, flaky texture; and a crisp outer crust. The amount of shortening should not exceed an amount that would provide a baked product having a gummy texture. Yet the amount of shortening should not be so low that a laminated dough of the invention provides a baked product having a tough, dry, crumbly texture and a less than desirable specific volume.

A laminated dough useful in the present invention typically includes shortening in the layer dough as well as the shortening layers. The shortening in the layer dough can be effective as a plasticizer. That is, the shortening can be effective to provide extensibility to the layer dough. The extensibility contributes to the desirable specific volume of a baked product prepared from a laminated dough of the invention.

The amount of shortening in the layer dough typically is in a range of between about 0.5 weight percent and about 10 weight percent, preferably between about 1 weight percent and about 5 weight percent, and more preferably between about 1 weight percent and about 3 weight percent based on the total weight of the laminated dough.

The shortening in the shortening layers typically is in a range of between about 10 weight percent and about 20 weight percent, preferably between about 12 weight percent and about 16 weight percent, and more preferably between about 13 weight percent and about 15 weight percent based on the total weight of the laminated dough.

With the vertical orientation of the dough during baking it is important that not too much shortening is used in the shortening layers that the shortening pools as it is heated. This running and pooling of the shortening is undesirable.

Water-Binding Agent

A layer dough useful in the present invention further includes a water-binding agent. A water-binding agent suitable for use in a layer dough of the invention contributes to the hydration of the dough. A water-binding agent may also improve the development of the dough by improving the resistance of the dough to shearing during mixing.

Although this invention is not limited to any particular theory, it is believed that a water-binding agent allows the dough to retain high amounts of water and to expand during baking.

A water-binding agent suitable for use in a layer dough of the invention includes gelling agents and thickening agents. A gelling agent suitable for use with a laminated dough of the invention includes any compound that can form a gel. Examples of gelling agents include hydrocolloid gums and gel-forming proteins. Examples of suitable hydrocolloid gums include pectin, alginate, carrageenan, carboxymethyl cellulose, methyl cellulose, hydroxypropyl cellulose, hydroxypropylmethyl cellulose, etc.

Examples of suitable gel-forming proteins include gelatin, hydrolyzed gelatin, gelatin precursors such as collagen, etc.

A thickening agent suitable for use with a layer dough of the invention includes any compound that can increase the viscosity of a medium when the compound is dispersed in water. An example of a suitable thickener includes guar gum.

In one embodiment, the water-binding agent includes pectin. In another embodiment, the water-binding agent includes gelatin. In still another embodiment, the water-binding agent includes guar gum and at least one of pectin and gelatin.

Some gelling agents that have been particularly useful in a laminated dough of the invention are those packaged with an amylase such as, for example, GENU® FREEZE (Copenhagen Pectin A/S, Denmark) and GENU® FOOD GUM X6021 (Copenhagen Pectin A/S, Denmark). Thus, a layer dough of the invention can include an amylase. An amylase includes any enzyme that can hydrolyze O-glucosyl linkages in starch, glycogen, and related polysaccharides. Examples of amylase include α-amylase.

The amount of water-binding agent in a layer dough of the invention is effective to provide desirable baking development and desirable frozen stability.

The amount of water-binding agent should not exceed an amount that would result in a laminated dough that is so dry that it loses its ability to expand. Yet the amount of water-binding agent should not be so low that a laminated dough of the invention is so soft that it loses its layers because the layer dough merges with the shortening layers or so low that the amount of water absorbed into the dough is so negligible that a desirable baked product cannot be prepared.

The amount of water-binding agent can be in a range of between about 0.2 weight percent and about 1 weight percent, preferably between about 0.5 weight percent and about 0.9 weight percent, and more preferably between about 0.6 weight percent and about 0.8 weight percent based on the total weight of the laminated dough. Moreover, a laminated dough of the invention typically includes a ratio of water-binding agent to water of between about 0.005:1 and about 0.05:1, preferably between about 0.015:1 and about 0.025:1, and more preferably between about 0.01:1 and about 0.03:1.

Leavening Agent

A laminated dough useful in the invention also includes a leavening agent to increase the volume and alter the texture of a baked product prepared by a laminated dough of the invention. Leavening agents suitable for use in a laminated dough of the invention include air, steam, chemical leaveners, yeast, etc.

The amount of a leavening agent is effective to leaven a baked product prepared from a laminated dough of the invention. A leavening agent is typically present in an amount of between about 0.5 weight percent and about 6 weight percent, preferably between about 0.75 weight percent and about 5 weight percent, and more preferably between about 2 weight percent and about 4 weight percent based on the total weight of the laminated dough.

Additional Ingredients

The laminated dough useful in the invention also typically includes sugar and salt. Salt can enhance the flavor of a baked product prepared from a laminated dough of the invention, impart toughness to the gluten, and provide strength to the crumb. Salt can be present in an amount effective to provide a desirable flavor. Salt is typically present in a range of between about 0.3 weight percent and about 1 weight percent. Sugar can also enhance the flavor of a baked product prepared from a laminated dough of the invention. Sugar acts as a substrate for yeast and as a starting material for the Maillard reaction, which facilitates color formation of the crust. Sugar is typically present in a range of between about 1 weight percent and about 3 weight percent. Suitable sugar includes granulated sugar, honey, high fructose corn syrup, etc.

The dough useful in the invention can also include additives, for example, emulsifiers, dough-developing agents, nutritional supplements, flavorings, shelf-life stabilizers, organic acids, oxidizers, and the like. Additives can modify texture or any number of characteristics of a laminated dough of the invention or a baked product resulting therefrom.

An emulsifier can influence the texture and homogeneity of the dough mixture, increase dough stability, and improve the eating quality of a baked product. An emulsifier includes nonionic surfactants, anionic surfactants, and cationic surfactants. Suitable emulsifiers include, for example, lecithin, mono- and diglycerides of fatty acids, propylene glycol monoesters and diesters of fatty acids, glyceryl-lacto esters of fatty acids, ethoxylated monoglycerides and diglycerides, sodium stearoyl lactylate, etc.

In one embodiment, a laminated dough of the invention may include an emulsifier including sodium stearoyl lactylate, diacetyl tartaric acid ester of monoglycerides and diglycerides (DATEM), or a combination thereof.

A dough-developing agent can enhance the viscosity, texture, and plasticity of a laminated dough of the invention. Any number of dough-developing agents can be used including, for example, azodicarbonamide, ascorbic acid, sodium bisulfite, potassium bromate, benzoyl peroxide, and organic acids such as potassium sorbate or salts of organic acids.

In one embodiment, a laminated dough of the invention may include a dough—developing agent including azodicarbonamide, ascorbic acid, or a combination thereof.

A nutritional supplement such as, for example, vitamins, minerals, proteins, and the like can be added to a laminated dough useful in the invention. Examples of nutritional supplements include thiamin, riboflavin, niacin, iron, calcium, etc.

Flavorings such as, for example, sweeteners, spices, and specific flavorings can be added to a laminated dough useful in the invention. Sweeteners include, for example, regular and high fructose corn syrup, sucrose (cane or beet sugar), dextrose, and the like.

Shelf-life stabilizers such as, for example, preservatives and mold inhibitors can be added to a laminated dough useful in the invention. Suitable shelf-life stabilizers include, for example, sodium salts of propionic or sorbic acids, sodium diacetate, monocalcium phosphate, lactic acid, stearoyl lactylate, ascorbic acid, etc.

Oxidizers such as, for example, ascorbic acid, azodicarbonamide, etc., can also be added to a laminated dough of the invention to provide a fermented flavor.

Table 1 illustrates the useful, preferred, and more preferred ranges of the flour, protein supplement, shortening, water-binding agent, and leavening agent included in a laminated dough of the invention.

TABLE 1
Ingredients In A Laminated Dough Useful In The invention

| | WEIGHT PERCENT | | |
|---|---|---|---|
| | | | MORE |
| INGREDIENTS | USEFUL | PREFERRED | PREFERRED |
| Flour | 30-55 | 35-50 | 40-45 |
| Protein Supplement | 0.4-2.5 | 0.6-2.3 | 0.8-1.5 |
| Shortening | | | |
| Layer Dough | 0.5-10 | 1-8 | 1-3 |
| Shortening Layers | 10-20 | 12-16 | 13-15 |
| Water-Binding | 0.2-1 | 0.5-0.9 | 0.6-0.8 |
| Agent | | | |
| Leavening Agent | 0.5-6 | 0.75-5 | 2-4 |

A laminated dough useful in the invention can be free of relaxing agents that facilitate a dough's resistance to mechanical stresses such as mixing, sheeting, etc. In particular, relaxing agents can adversely affect the shelf life of frozen doughs as well as specific volume. The term “free of” as used herein includes an amount of less than 20 ppm, preferably no more than 15 ppm, and more preferably no more than 10 ppm based on flour. Relaxing agents can include reducing agents such as, for example, cysteine, bisulfite, sorbate, etc. In one embodiment, a laminated dough of the invention is free of cysteine.

A laminated dough useful in the invention can also be free of a modified starch (e.g., cross-linked starches derived from maize or tapioca).

One advantage of a laminated dough useful in the invention is that it does not need to be proofed or thawed prior to baking, which is useful for saving time and storage space. Another advantage of a laminated dough useful in the invention is that the dough is more resilient to temperature fluctuations so that it can maintain its stability and integrity.

Another advantage of a laminated dough of the invention is that the laminated dough does not need to be packaged under a modified atmosphere.

Processing

A laminated dough useful in the invention can generally be prepared by mixing the above-described ingredients to form a layer dough to provide the dough layers, rolling in the shortening layers, shaping the laminated dough, and optionally freezing the laminated dough. One skilled in the art having read the specification would understand that the mixing and rolling steps are generally performed using good laminated dough technique.

Mixing a Layer Dough to Provide the Dough Layers

A layer dough suitable for providing the dough layers in a laminated dough useful in the invention can be prepared according to methods known in the art.

In one embodiment, a layer dough can be prepared by combining all ingredients and mixing until the layer dough is fully developed. Fully developed refers to transforming the mixture into a cohesive mass such that the layer dough is substantially homogenous and soft.

A layer dough can be mixed in any mixer suitable for combining the ingredients and mixing until the layer dough is fully developed. An example of a suitable mixer includes a vertical mixer (Hobart, Troy, Ohio). During mixing, the layer dough useful in the invention is desirably maintained at a temperature that maintains the structure of the layer dough to facilitate handling of the layer dough. Typically the temperature should be in a range of between about 60° F. and about 75° F., preferably between about 62° F. and about 72° F., and more preferably between about 64° F. and about 68° F.

Preferably the mixer is equipped with a refrigeration system such as, for example, a jacketed glycol coolant to maintain the layer dough useful in the invention within the desirable temperature range.

To maintain the desirable temperature, the water added should be at a temperature suitable for maintaining the dough at the desirable temperature. Preferably the water is at a temperature of between about 60° F. and about 65° F. To bring the water to a temperature suitable for maintaining the layer dough at the desirable temperature, a portion of the water can be replaced by shaved or crushed ice. The amount and size of the shaved or crushed ice can be determined so that the ice can melt in the water, the dough, or both during mixing without leaving ice in the mixed dough. If ice remains in the mixed dough, wet spots will appear in the layer dough, which is undesirable. The size of the shaved or crushed ice can typically be up to about 1 cm. The portion of water that is replaced by shaved ice can be up to about 50 weight percent of total water.

The layer dough is mixed at a speed and time that are suitable for fully developing the layer dough. For example, the ingredients can initially be mixed on low speed for about 30 seconds and then mixed on medium speed for between about 8 minutes and about 12 minutes. These times and speeds are merely illustrative and can vary depending on the amount of laminated dough being mixed and on the type of mixer.

After mixing, a layer dough desirably has a temperature of between about 60° F. and about 75° F., preferably between about 62° F. and about 72° F., and more preferably between about 64° F. and about 68° F.

Within 10 minutes of being mixed to full development, a layer dough desirably has a consistency of between about 700 Brabender units (B.U.) and about 1300 B.U., preferably between about 800 B.U. and about 1200 B.U., and more preferably between about 900 B.U. and about 1100 B.U. This dough consistency can be determined by a Farinograph measurement. Farinograph measurements are known to one of skill in the art and refer to a dough's resistance to mixing. A Farinograph measurement involves determining the peak amplitude of the layer dough.

After mixing, the dough is sheeted and shaped into a rectangle. A dough can be sheeted in a sheeter such as a sheeter manufactured by Rondo (Burgdorf, Switzerland).

Rolling in a Shortening

A laminated dough useful in the invention is prepared by rolling shortening into the layer dough. The rolling step can be performed according to methods known in the art. The term “rolling” as used for this invention includes the incorporation and maintenance of layers of shortening between adjacent layers of dough. Shortening can be rolled into the dough to provide a laminated dough of the invention having between about 8 and about 64 shortening layers. The number of layers and thickness is discussed in more detail below.

To prepare the shortening to be rolled into the layer dough, the shortening is creamed. Creaming shortening includes mixing shortening in a manner effective to soften the shortening. Preferably the shortening is softened to an extent that it simulates extruded shortening. The creaming process can be performed in a mixer. If the shortening is undermixed, then undesirable lumps of shortening can remain in the creamed shortening. But if the shortening is overmixed, then the shortening can break down resulting in free water.

In one instance, the shortening can be creamed by mixing the shortening at low speed of a mixer for between about 1 minute and about 2 minutes and then mixing the shortening at medium speed of a mixer for between about 3 minutes and about 4 minutes.

After creaming, the shortening is sheeted. After sheeting, the shortening is cooled to a temperature suitable for good lamination technique. In one embodiment, the shortening that is creamed and sheeted includes butter. When butter is rolled into a dough to prepare a laminated dough of the invention, the butter can be at a temperature of between about 48° F. and about 68° F., preferably between about 50° F. and about 65° F., and more preferably between about 50° F. and about 55° F.

Generally shortening can be rolled into the layer dough by first wrapping a slab of shortening with layer dough and sheeting the wrapped shortening to prepare a sheet dough. The sheet dough can be repeatedly folded and sheeted to provide a laminated dough of the invention. Between sheeting steps, the dough can be refrigerated to avoid having the shortening melt into the layer dough and to allow the layer dough to rest so it can sheet without tearing.

After completion of the folding and sheeting sequence, the laminated dough useful in the invention can be rolled and shaped.

The thickness of the individual dough layers and the number of layers is somewhat important in the present invention. Since the orientation of the laminated dough during baking substantially changes the appearance of the product as compared to the raw laminated dough product and the baked specific volume of the product as compared to conventionally orienting the same dough piece, it is somewhat important that the thickness of each layer of laminated dough and the number of layers is optimized in order to achieve a desirable baked product. It has been found that laminated dough with an increased number of thin layers is more desirable as compared to one having fewer thicker layers. More numerous thin layers result in a baked product with a fluffy texture. It is proposed that this desirable fluffy texture results from the expansion upon baking. This is most likely due to the fact that the greater number of thin layers have collectively more shortening in between the layers. An increased amount of shortening that includes an aqueous phase results in an increased amount of steam created during baking. This steam pushes the thinner, more numerous dough layers apart resulting in a fluffier product. In contrast, a laminated dough product having fewer thicker layers may result in a more bread like product once it is baked. It is believed that consumers prefer the fluffier (more thin layers) product because it allows for greater peelability. What is meant by peelability is that the dough layers are easily separated or peeled apart. In contrast, the product having fewer thick layers may not provide as great an ease of peeling.

The overall thickness of the dough sheet from which individual dough pieces are cut is important. It was found that a sheet thickness or depth of at least about one inch is desirable. If the raw individual dough pieces have a thickness or depth of at least about one inch “d” as shown in FIGS. 1 and 2 the dough piece tended to remain substantially vertical through baking. One skilled in the art will understand that due to the horizontal expansion and the action of gravity the outer layers of the laminated dough piece tend to angle down toward the baking surface during baking in a divergent manner. The amount of angling or fanning, if at all, is partially dependent upon the overall height of the raw dough piece. If the raw dough piece was tall, the outermost layers would tend to angle down away from vertical greatly whereas if the raw dough piece was shorter, the outermost layers may not angle down from vertical much at all. The fanning of the outer dough layers will also depend upon the stiffness of the dough and/or upon the initial temperature of the dough. That is, whether or not the dough was frozen when placed in the oven.

As explained above, it was found that consumers preferred a greater number of thin layers of dough to comprise the dough sheet as compared to a fewer number of thicker dough sheets. It was found that the thickness of each individual dough sheet was preferably in the range of 0.9 to about 1.1 mm thick. Using individual dough sheets in the provided range of thickness it was found that in order to achieve a laminated dough sheet of at least about one inch thickness, preferably between about 20 to about 28 individual dough layers were needed, more preferably 22 to 26 layers, and most preferably 23 to 25 layers.

In one embodiment, a laminated dough having 27 dough layers can be prepared. To prepare a laminated dough having 27 dough layers, the following procedure can be used. First, to roll the shortening into the dough, a slab of shortening can be placed onto a slab of layer dough, and the layer dough can be wrapped up and over the shortening. The layer dough and shortening can be sheeted to provide a sheet of dough having a thickness of between about 9 mm and about 13 mm, preferably between about 10 mm and about 12 mm, and more preferably between about 10.5 mm and about 12.5 mm. The layer dough can be folded into three, and the folded layer dough can be sheeted to provide a thickness of between about 9 mm and about 13 mm, preferably between about 10 mm and about 12 mm, and more preferably between about 10.5 mm and about 12.5 mm. The layer dough can be folded into three and sheeted to provide a thickness of between about 9 mm and about 13 mm, preferably between about 10 mm and about 12 mm, and more preferably between about 10.5 and about 12.5 mm. The layer dough and shortening can then be folded into three and sheeted to provide a laminated dough of the invention having a thickness of between about 20 mm and about 25 mm, preferably between about 21 mm and about 24 mm, and more preferably between about 21 mm and about 25 mm.

An example of another laminated dough composition and method of making such laminated dough is described in co-pending U.S. patent application Ser. No. (Attorney Docket No. PIL0147/US), entitled “Tender Laminated Biscuits” filed on the same date as this application to Boyle, et al. and commonly assigned to The Pillsbury Company.

Shaping a Laminated Dough of the Invention

The laminated dough can then be rolled and formed into desirable shapes. The rolled and shaped laminated dough does not need to be flattened by, for example, passing between rollers to prepare a desirable baked product.

Some shapes are more desirable than other shapes for the raw dough pieces. Preferable shapes are those that are easily placed upright so that the laminated layers are perpendicular to the baking surface. Such shapes desirably have a substantially flat edge or surface as shown in FIGS. 1 and 2, edges 2 and 22, respectively, are substantially flat. Such substantially flat edges 2 and 22 allow for easy placement against a baking sheet and allow the plurality of laminated sheets to stand substantially upright. Additionally, a desirable shape has a heightened portion extending in a direction opposite the flat surface. The heightened portions 4 and 24 shown in FIGS. 1 and 2 tend to allow the dough product to fan horizontally in a more pronounced manner than the dough product would fan without the heightened portion. A dough piece may have one or more heightened portions of varying or equal height. It is believed that such heightened portion(s) cause the dough piece to splay open more dramatically as shown in FIGS. 4 and 5 at 92 and 142, respectively.

For the purpose of ease of placement, it is preferable that the product be asymmetrical from one perspective. For example, raw dough pieces shaped like a house or a domed square are desirable. Such a shape is desirable from a consumer product perspective because it is easy to describe how to place the product on the baking sheet. For instance, in the case of a generally house shaped raw dough piece as shown in FIG. 1, one could easily describe that the point of the “roof” of the dough piece (4) should be placed up. Likewise, in the case of a domed square of FIG. 2, one could state that the dome or rounded portion (24) should be placed up. There are undoubtedly other shapes that will perform well and will provide a horizontally expanded baked good. While it would not be as easy to describe how to place the raw dough pieces on a baking sheet, equilateral pentagonal or equilateral hexagonal shaped raw dough pieces would also likely provide desirable baked product shapes. One skilled in the art will recognize that the shape of the raw dough piece is somewhat personal preference, as the shape of the baked product will depend upon the shape of the raw dough piece.

The dimensions of the individual pre-baked or raw laminated dough pieces are also somewhat important. The desired appearance of the baked product is one that has spread out horizontally across the baking sheet. If the height of the dough piece is too great, the dough will flop over prematurely and will not expand horizontally appropriately. A prematurely flopped over dough piece or prematurely partially flopped over dough piece will bake similarly to any conventionally placed laminated dough piece having its laminated layers parallel to the baking sheet. For the purposes of this invention, such a result is undesirable. It has been found that frozen dough pieces preferably have a height (h in FIGS. 1 and 2) of between about one to two inches. More preferably a frozen dough piece has a height of about 1.5 inches to about 1.9 inches, and most preferably of about 1.7 to about 1.8 inches. Most preferably during baking the laminated layers expand horizontally and finally angle downward or partially tip over so that the appearance of the baked product from the side has a fan-like shape. In other words, the outermost layers approach horizontal while the layers close to middle remain almost vertical. Ideally, the outside layers of the baked product are at about a 75 to 45 degree angle off vertical. However, the amount of tipping or angling of the outer layers will depend in part upon the height of the raw dough piece. If the raw dough piece is short, very little tipping or angling of the outer most layers of the product may occur. The shorter the dough piece, the less fanning that occurs during baking and the more purely horizontal accordion like expansion that occurs.

Dough pieces may also be baked in tins or other types of constraint. If the dough pieces 33 are placed so the laminated layers are substantially vertical in the center of a muffin tin 36 depression as shown in FIG. 3, the bottom of the dough piece will be horizontally restrained from expanding beyond the diameter of the tin. The top of the dough piece will expand. Dough pieces baked in such constraints are desirable and result in a fanned or dome top roll shape 96 as shown in FIG. 4. In contrast, laminated dough baked in a substantially vertical orientation without restraint results in more of an accordion or caterpillar shaped baked product 146 as shown in FIG. 5.

As one can understand, it is desirable that the height of the raw dough piece is short enough so that the piece does not tip or flop over either before baking or early in the baking process. Such tipping or flopping would counteract the placement of the layers in a fashion substantially perpendicular to the baking surface. The height of the raw dough piece may vary depending upon the stiffness of the dough and/or whether or not the dough piece is at refrigeration temperature or frozen. A tall piece of frozen dough could stand upright because it was stiff whereas a room temperature dough piece of the same height might immediately tip or flop over. One skilled in the art will understand that the height of the dough piece is somewhat dependent upon the temperature of the raw dough and upon the stiffness of the laminated dough.

The individual layers of the raw dough piece used in the invention should not be fused together at the edges. Such a fusion or smudging of the layers would reduce the amount of expansion of the layers along the edges of the dough piece. Preferably the layers of the dough piece are allowed to expand throughout the piece of dough, including the edges. A different expansion would result in the baked good if the layers of the laminated dough were allowed to fuse or were caused to fuse when cutting the individual dough pieces from a sheet of laminated dough. Co-pending U.S. patent application Ser. No. Attorney Docket No. PIL0146/US filed on the same date as this application, entitled “Method and Apparatus for Cutting Dough with Nested Pattern Cutters” to D. Maniak et al. commonly assigned to The Pillsbury Company, discloses and describes an apparatus and method of cutting laminated dough such that the edges are not fused together or smudged. Such application is hereby expressly incorporated by reference in its entirety.

If desired, the formed laminated dough can be transferred to any container suitable for freezing. The laminated dough of the invention does not need to be stored in a package having a modified atmosphere.

Freezing a Laminated Dough of the Invention

After a laminated dough of the invention is formed into a desirable shape and deposited into a container, the laminated dough of the invention is optionally frozen to a temperature suitable for shipping the laminated dough of the invention. A laminated dough of the invention is preferably frozen as quickly and completely as possible. A laminated dough of the invention can be frozen at a temperature of between about −10° F. and about −15° F. Generally this freezing process reduces the temperature of the laminated dough of the invention to at least 5° F.

Baked Product

A baked product of the invention can be prepared after freezing without thawing and proofing the laminated dough of the invention before baking the laminated dough. That is, the laminated dough of the invention can be removed from the freezer and be baked immediately in an oven without undergoing a thawing step. The oven can be preheated or cold.

In one embodiment, the laminated dough of the invention includes a house shaped piece as shown in FIGS. 1 and 3. A frozen house shaped laminated dough piece can be baked at a temperature of between about 340° F. and about 375° F., preferably between about 345° F. and about 355° F., and more preferably between about 348° F. and about 352° F. until golden brown.

Before baking, a laminated dough of the invention can be brushed with an egg wash to provide the baked product with a rich finish. An egg wash is known to one of skill in the art and typically includes egg and water.

A baked product of the invention has a baked specific volume of at least 2.5 cc/g. A baked product of the invention preferably has a baked specific volume of between about 2.6 cc/g and about 3.1 cc/g and more preferably has a baked specific volume of between about 2.7 cc/g and about 2.9 cc/g.

If muffin tins were used to constrain the horizontal expansion of the dough pieces along the bottom of the product it seems likely that the size of the dough piece would be chosen to allow the dough piece to stand upright in the bottom of each muffin depression as shown in FIG. 3. A dough piece having a width of up to about 2 inches allows easy placement into a muffin tin. If the height of the raw dough piece protrudes above the top of the muffin tin, baking dough pieces in a muffin tin would allow the top of the dough piece to expand horizontally during baking but the bottom of the dough piece would be constrained as shown in FIG. 4. Once such a baked product is removed from the muffin tin it would resemble a fan type shape. In addition to using muffin tins as constraints, other constraints are possible and may be used to constrain part of a raw dough piece whose individual layers are substantially vertical during baking.

Variations within the scope of the invention will be apparent to those skilled in the art.

We claim:

1. A raw laminated dough product comprising multiple layers and having a substantially flat surface made up of ends of multiple layers and a heightened portion of multiple layers extending in an opposite direction from said substantially flat surface so that said substantially flat surface can be supported by a baking surface during baking while the laminated layers are vertical and so that the heightened portion of the laminated layers can expand in a horizontal fashion.

2. The dough product of claim 1 wherein the substantially flat surface of the raw dough piece comprises a width that is greater than a height created by the heightened portion.

3. The dough product of claim 1 wherein the raw dough piece is placed in the oven for baking while frozen.

4. The dough product of claim 1 wherein a depth of the raw dough product created by the multiple layers is deep enough so that the laminated layers remain substantially vertical during baking.

5. The dough product of claim 1 wherein at least two sides extend between the substantially flat surface and the heightened portion.

6. The laminated dough product of claim 1 wherein the substantially flat surface is constrained at the bottom so that the heightened portion expands more than the substantially flat surface.

7. A method of baking a raw dough product having a plurality of laminated layers comprising the steps of
a) placing a substantially flat surface of a raw dough product on a support such that the plurality of laminated layers are generally perpendicular to the support and so that a heightened portion that extends in an opposite direction as the flat surface extends substantially upward,
b) baking the dough product such that laminated layers expand horizontally relative to an adjacent layer.

8. The method of claim 7 wherein the piece of laminated dough is partially constrained thus minimizing the horizontal expansion of the dough product in the area of the constraint during baking.

9. The method of claim 7 wherein the raw dough piece is frozen when baking begins.

10. The method of claim 7 wherein the depth of the raw dough product created by the plurality of laminated layers is deep enough so that the laminated layers remain substantially vertical during baking.
